(19) United States
(12) Patent Application Publication
(10) Pub. No.: US 2007/0162336 A1
(43) Pub. Date: Jul. 12, 2007

(54) METHOD AND SYSTEM FOR SURPLUS MANAGEMENT

(76) Inventor: Mashhur Zarif Haque, Lawrence, KS (US)

Correspondence Address: SACHNOFF & WEAVER, LTD., 10 SOUTH WACKER DRIVE, CHICAGO, IL, 60606-7507, US

(21) Appl. No.: 11/561,946

(22) Filed: Nov. 21, 2006

Related U.S. Application Data
(60) Provisional application No. 60/739,164, filed on Nov. 23, 2005.

(51) Int. Cl. G06Q 30/00

(52) U.S. Cl. 705/14

(57) ABSTRACT

A surplus management system disclosed herein includes a promotion module adapted to generate promotions based on the surplus, a scheduler module adapted to schedule the promotions over a period, a coupon generation module adapted to generate coupons for the promotion, a database adapted to store the promotion, the schedule and the coupons, and a website for publishing the promotion, the schedule and the coupons. An embodiment of the surplus management system also allows a user to request bidding for a party event and to receive a number of bids in response to such request.

### CROSS REFERENCE TO RELATED APPLICATIONS

This application claims priority of the provisional application No. 60/739,164 filed on Nov. 23, 2005 in the name of M. Zarif Haque and entitled “Method and System for Surplus Management,” which is incorporated herein by reference in its entirety.

### FIELD

This application generally relates to field of surplus management and specifically to the field of surplus management using a website.

### BRIEF DESCRIPTION OF THE DRAWINGS

While the appended claims set forth the features of the present surplus management system disclosed herein with particularity, the system, together with its objects and advantages, may be best understood from the following detailed description taken in conjunction with the accompanying drawings, of which:

FIG. 1A illustrates a flowchart of the manager interface according to an embodiment of the system for surplus management disclosed herein;

FIG. 1B illustrates an initial search form according to an embodiment of the system for surplus management disclosed herein;

FIG. 2 illustrates a manager login page according to an embodiment of the system for surplus management disclosed herein;

FIG. 3 illustrates a manager login error page according to an embodiment of the system for surplus management disclosed herein;

FIG. 4 illustrates a manager restaurant listing according to an embodiment of the system for surplus management disclosed herein;

FIGS. 5 & 6 illustrate a restaurant editing form according to an embodiment of the system for surplus management disclosed herein;

FIG. 7 illustrates the calendar display page according to an embodiment of the system for surplus management disclosed herein;

FIG. 8 illustrates a adding special form according to an embodiment of the system for surplus management disclosed herein;

FIG. 9 illustrates a adding coupon form according to an embodiment of the system for surplus management disclosed herein;

FIG. 10 illustrates a special display page according to an embodiment of the system for surplus management disclosed herein;

FIG. 11 illustrates a deletion verification page according to an embodiment of the system for surplus management disclosed herein;

FIG. 12 illustrates my specials display page according to an embodiment of the system for surplus management disclosed herein;

FIG. 13 illustrates a presets page according to an embodiment of the system for surplus management disclosed herein;

FIG. 14 illustrates a preset calendar view page according to an embodiment of the system for surplus management disclosed herein;

FIG. 15 illustrates a daily pattern page according to an embodiment of the system for surplus management disclosed herein;

FIG. 16 illustrates a monthly pattern creation page according to an embodiment of the system for surplus management disclosed herein;

FIG. 17 illustrates a pattern creation page according to an embodiment of the system for surplus management disclosed herein;

FIG. 18A illustrates a coupon display page according to an embodiment of the system for surplus management disclosed herein;

FIG. 18B illustrates a client coupon calendar list according to an embodiment of the system for surplus management disclosed herein;

FIG. 19A illustrates a flowchart of the system administrator interface according to an embodiment of the system for surplus management disclosed herein;

FIG. 19B illustrates an alternate flowchart of the system administrator interface according to an embodiment of the system for surplus management disclosed herein;

FIG. 19C illustrates a system administrator global manager-listing page according to an embodiment of the system for surplus management disclosed herein;

FIG. 19D illustrates a system administrator manager restaurant-listing page according to an embodiment of the system for surplus management disclosed herein;

FIG. 19E illustrates a system administrator location list page according to an embodiment of the system for surplus management disclosed herein;

FIG. 19F illustrates a system administrator adding location form according to an embodiment of the surplus management disclosed herein;

FIG. 20 illustrates a system administrator adding manager form according to an embodiment of the system for the surplus management disclosed herein;

FIG. 21 illustrates a flowchart of the user interface according to an embodiment of the system for surplus management disclosed herein;

FIG. 22 illustrates a no search results page according to an embodiment of the system for surplus management disclosed herein;

FIG. 23 illustrates a alternate search form according to an embodiment of the system for surplus management disclosed herein;

FIG. 24 illustrates a search results display page according to an embodiment of the system for surplus management disclosed herein;

FIG. 25 illustrates a restaurant information display according to an embodiment of the system for surplus management disclosed herein;

FIG. 26 illustrates a coupon print display according to an embodiment of the system for surplus management disclosed herein;

FIG. 27 illustrates the large group form according to an embodiment of the system for surplus management disclosed herein; and

FIG. 28 illustrates a diagram of electronic communications network according to an embodiment of the system for surplus management disclosed herein.

### DETAILED DESCRIPTION

A surplus management system disclosed herein includes a promotion module adapted to generate promotions based on the surplus, a scheduler module adapted to schedule the promotions over a period, a coupon generation module adapted to generate coupons for the promotion, a database adapted to store the promotion, the schedule and the coupons, and a website for publishing the promotion, the schedule and the coupons. An embodiment of the surplus management system also allows a user to request bidding for a party event and to receive a number of bids in response to such request.

Embodiments of the surplus management disclosed herein are directed to a method and system for surplus management. More particularly, the surplus management disclosed herein is directed to a method and system for scheduling, distributing and broadcasting promotions to manage surplus. One embodiment may be used for automated, self-updating direct-to-market advertising in a variety of organizational settings. The embodiment includes the ability to: schedule promotions such as specials and coupons weeks, months or years in advance; tally website hits; track accounts receivables; and create and redeem gift certificates. To facilitate coupon and specials scheduling, the embodiment also includes the ability to schedule promotions on a specific day, a specified preset of days, or on a regularly scheduled pattern of days. The embodiment also includes the ability to review, manage, and statistically analyze data directed to the system.

In all, various embodiments of the surplus management disclosed herein are contemplated. One embodiment of the surplus management disclosed herein is presented to apply to the restaurant industry. This embodiment, however, is not limited to restaurants, or even the food industry, and may be adapted for use in any number of commercial industries, such as the automotive, real estate, entertainment, media, retail industry and communications industries, among others. The embodiment may also be applied in non-industrial settings which require the scheduling, distributing and broadcasting of promotions to manage the surplus of any matter, whether or not the matter bears intrinsic or extrinsic economic value. This embodiment may be applied to any organization.

As seen in FIG. 28, one embodiment of the surplus management system includes at least one database 2820, at least one readable medium 2810 whose contents cause at least one computer 2830 to operate, display and transmit surplus management interfaces, transmitting via at least one communications network 2850. One of skill in the art will appreciate that the foregoing tasks may be divided between more than one readable mediums 2810. Another embodiment of the surplus management disclosed herein further employs a means for displaying and a means for broadcasting data on any type of communications network, such as a telecommunications network, LAN or WAN or combinations thereof. The means for displaying data and the means for broadcasting data are varied. An Internet web browser is one example of the means for displaying data. One of skill in the art will appreciate that a non-browser, such as one or more file servers on an intranet, may also be used. A network protocol is one example of a means for broadcasting on a communications network, and one of skill in the art will appreciate that wired or wireless communication services, such as digital cable, cellular protocols, or any number of communication spaces may similarly be used.

For illustrative purposes only, embodiments of the surplus management system are described herein with reference to the restaurant industry. One embodiment of the surplus management system, as applied to the restaurant industry, incorporates both a user interface and a manager interface on a website. The term “user,” refers to a person or entity that is searching for promotions, including for example, coupons or specials. The term “manager,” refers to one who utilizes an embodiment and its features to manage surplus inventory. A “manager” may utilize the embodiment as both a “user” and a “manager”.

The embodiments, whether applied to the restaurant industry or any other organizational sector, may optionally use additional or fewer than two interfaces. Embodiments applied to the restaurant industry which refer to the user and manager interfaces may include both user and manager access to a website. The user in such an embodiment refers to a searcher and the manager refers to a manager of surplus, wherein the user searches for surplus inventory while the manager manages surplus inventory. In such an embodiment, management of surplus inventory entails scheduling, distributing and broadcasting promotions to reduce an establishment's surplus of menu items. A manager may also manage collected data such as user feedback, database hits, coupon effectiveness, specials effectiveness, or any other type of data that increases the effectiveness of a promotion for managing surplus. Effectiveness may be measured and studied by any number of known data tracking or statistical means.

In a further embodiment, a manager's access to the manager interface may be restricted by any number of known security means, and varying levels of authorization may be defined to correspond to varying levels of a restricted manager interface. Irrespective of the interface used, one of skill in the art will appreciate that any data stored in the database or otherwise transmitted to the website may also be encrypted for purposes of security.

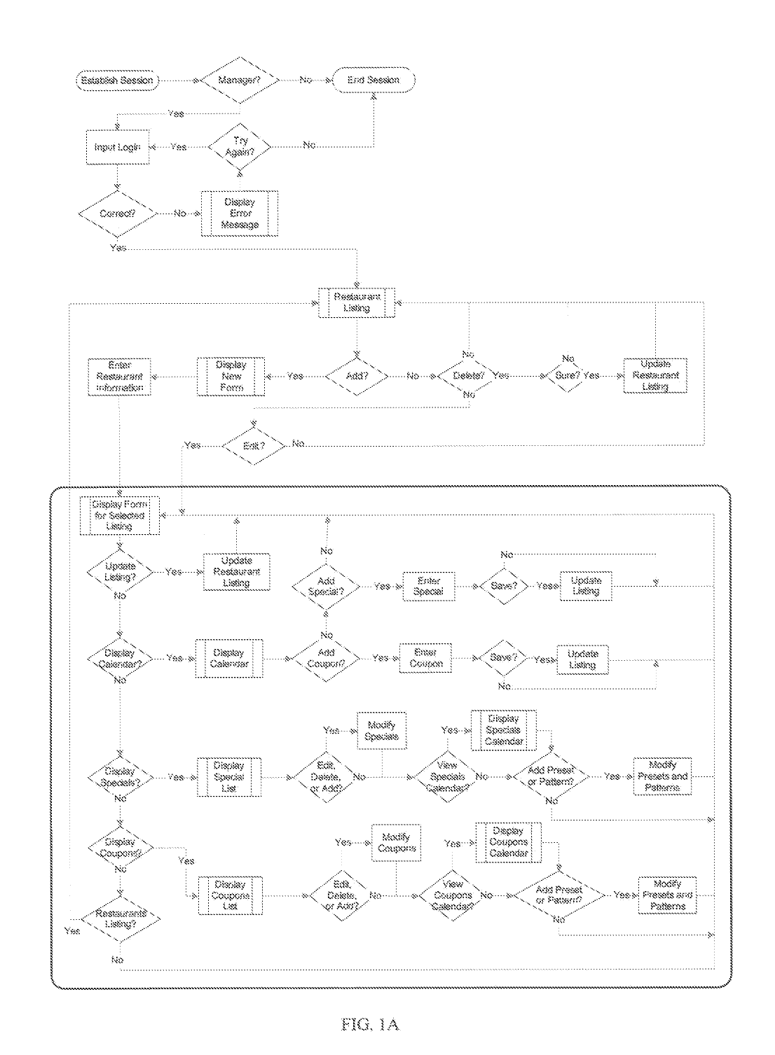

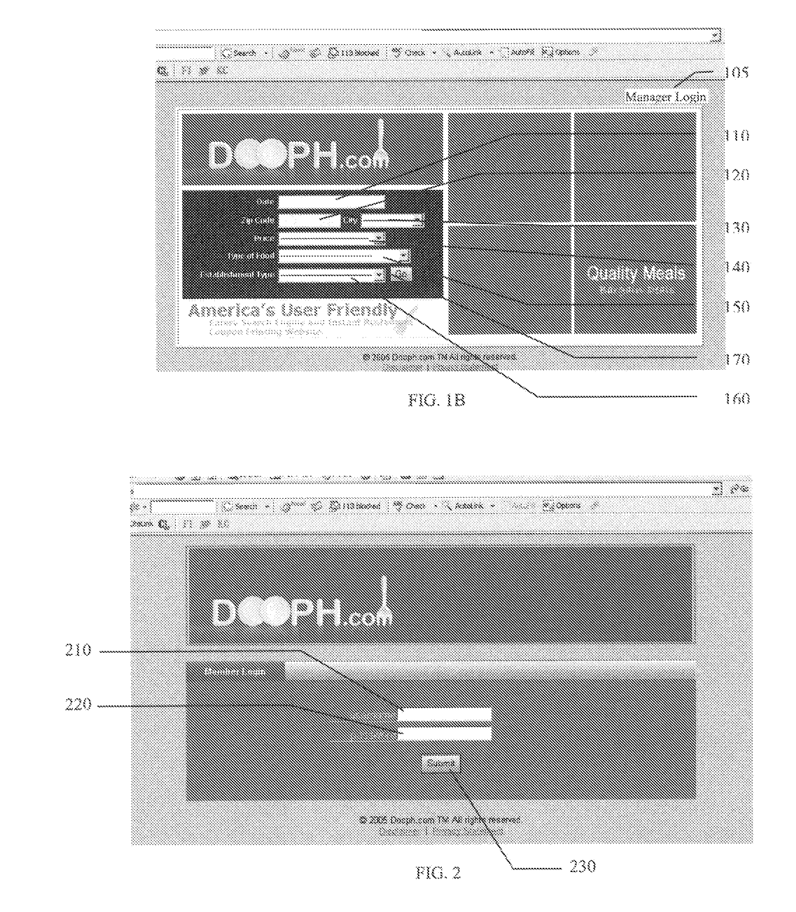

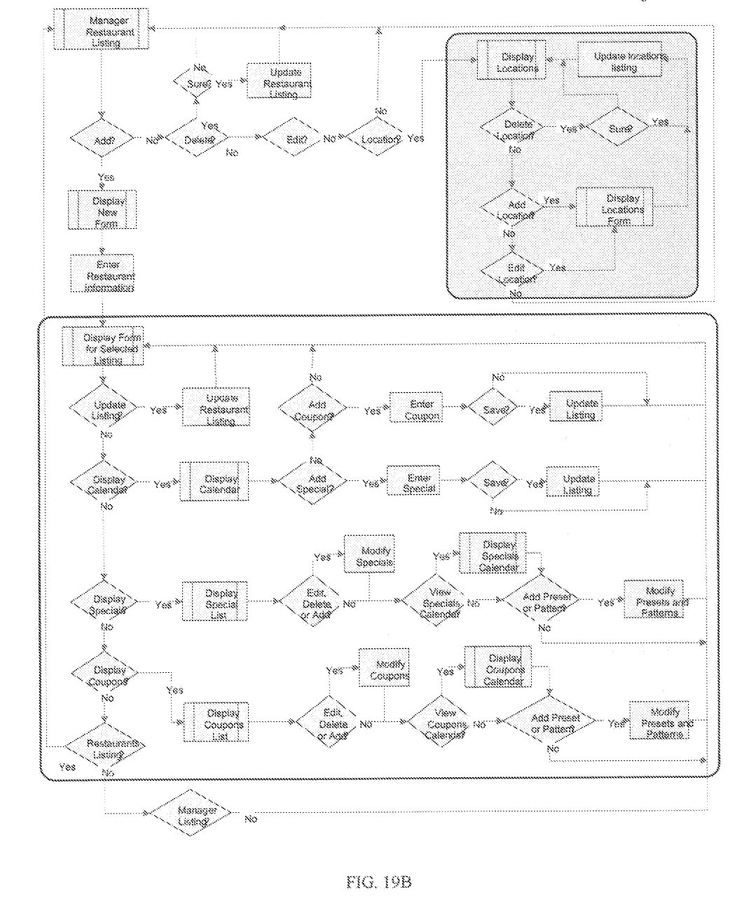

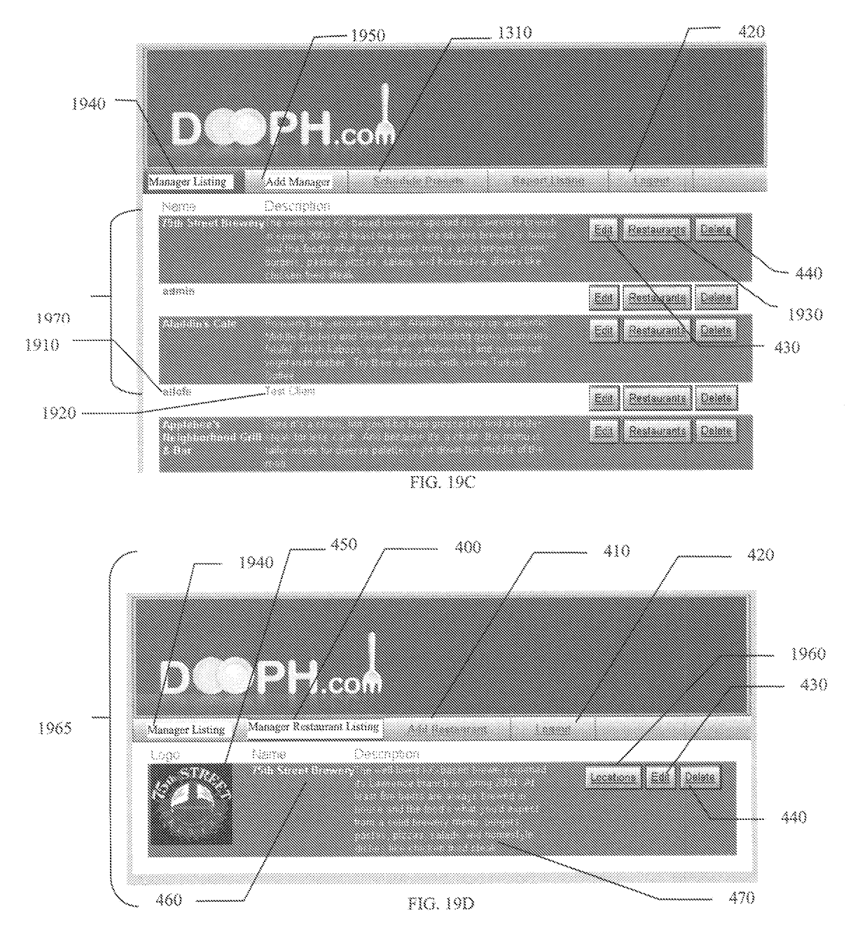

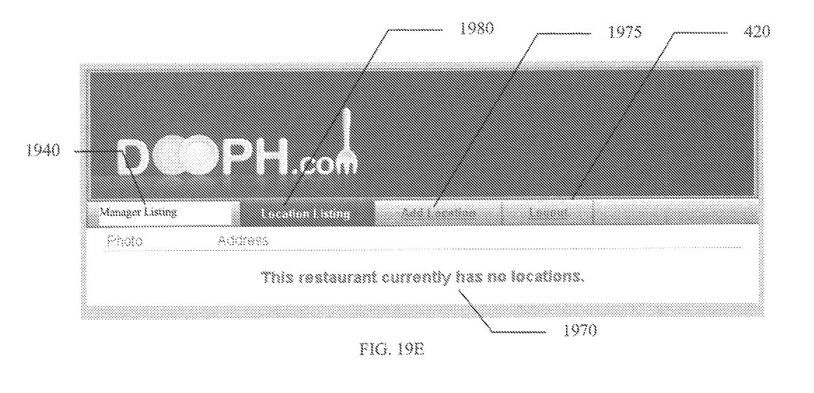

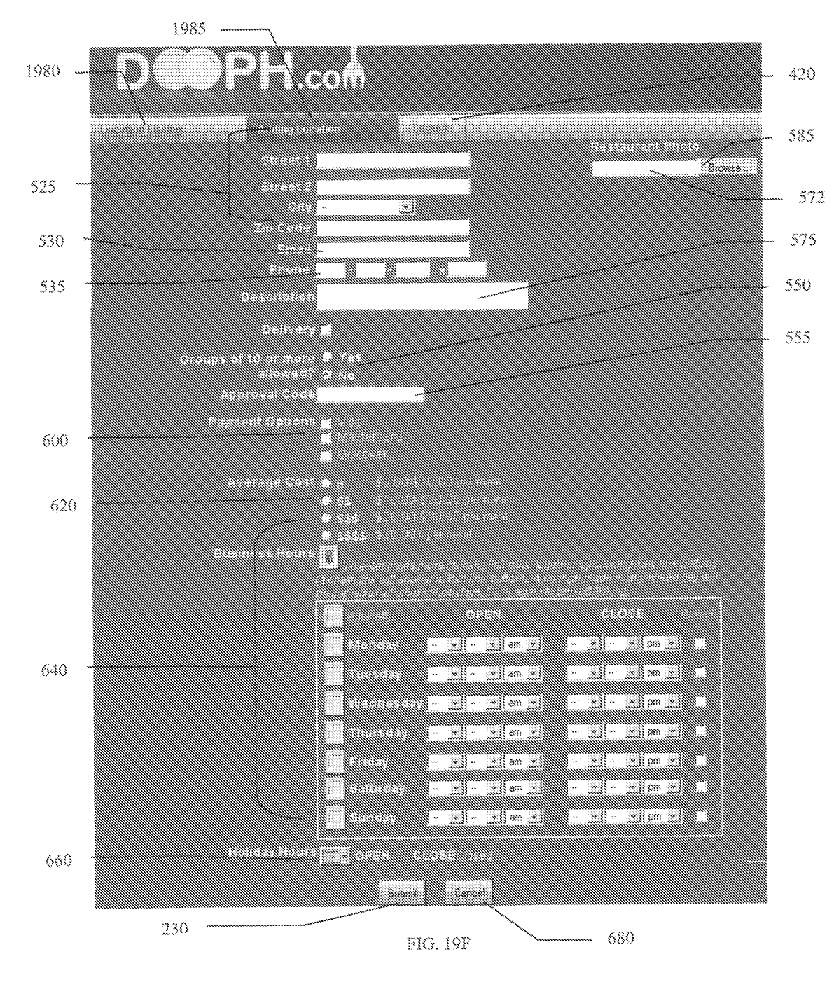

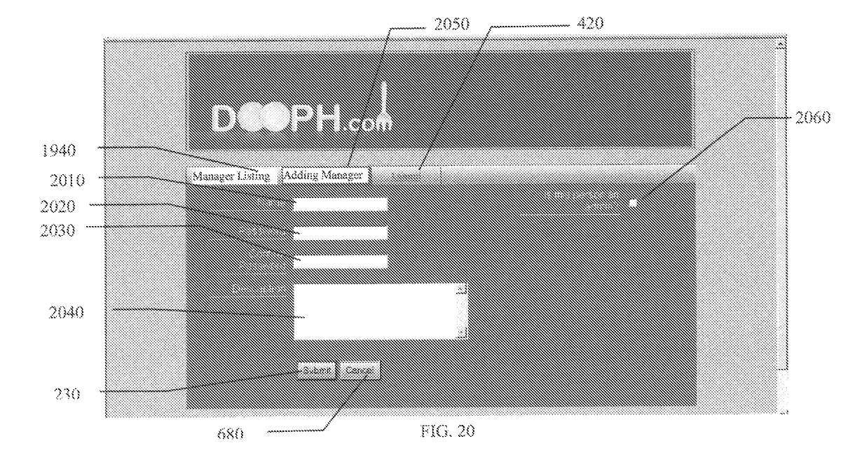

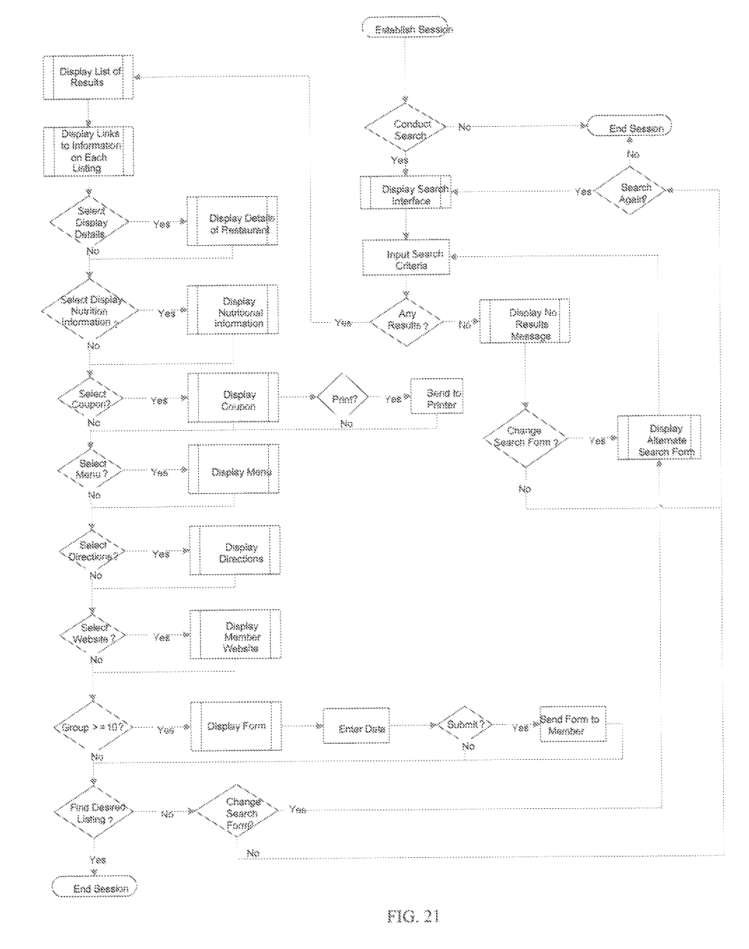

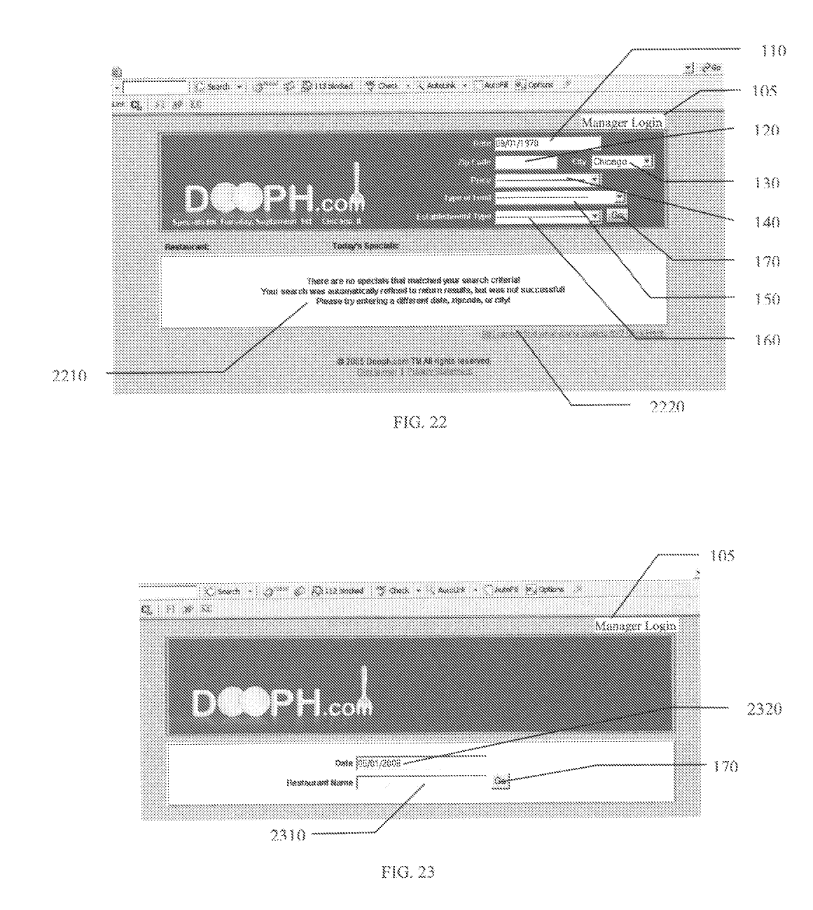

By way of overview, FIGS. 1A, 19A and 21 illustrate embodiments of the logical progression through the “manager”, “system administrator” and “user” interfaces, respectively. More particularly, FIGS. 1B-18B illustrate embodiments of the manager interface, FIGS. 19B-20 illustrate embodiments of the system administrator interface and FIGS. 22-27 illustrate embodiments of the user interface.

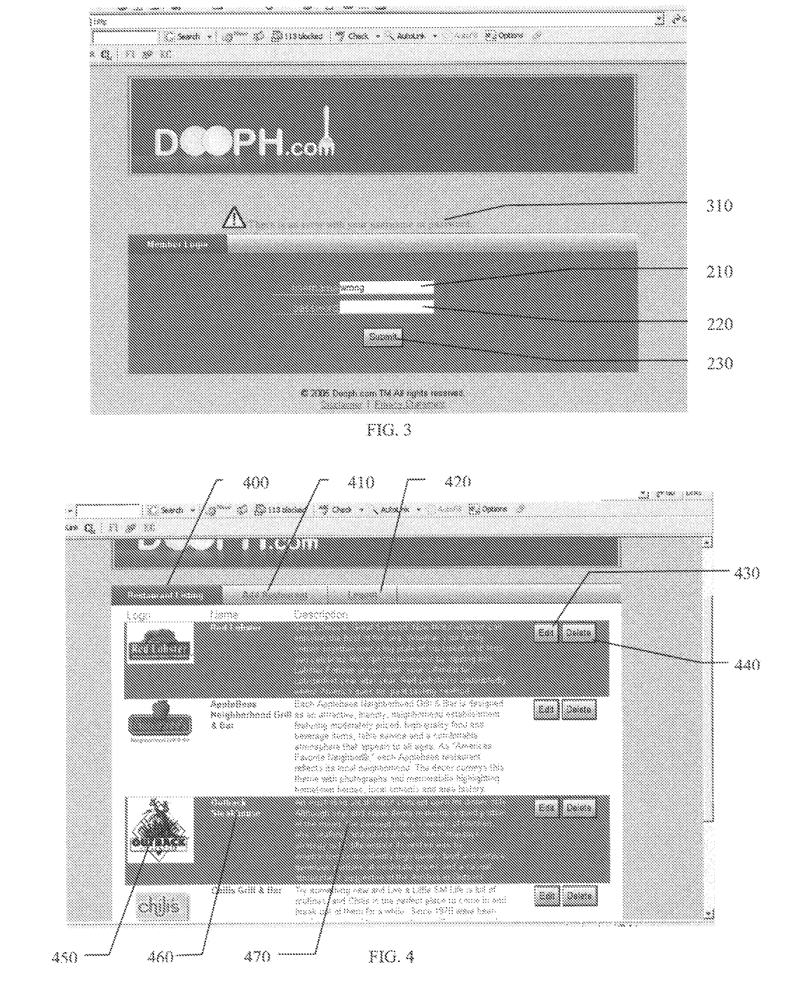

FIG. 1A represents an embodiment of a manager's logical progression through the manage interface as displayed on an Internet browser. The flowchart depicted in FIG. 1A begins by determining whether the person or entity is utilizing the embodiment as a manager. If utilizing the embodiment as a manager, the person or entity will engage on the manager login interface 105 as best seen in FIG. 1B. If the person or entity is not utilizing the embodiment as a manager, then the session ends. Otherwise, the session continues as seen in FIG. 1A. The manager then inputs login information, the usemame 210 and the password 220 as shown in FIG. 2. If the information is incorrect, the manager is shown a login error message 310 as shown in FIG. 3. If the manager chooses not to try again, the session ends. If the manager chooses to try again, the manager may re-enter the login information.

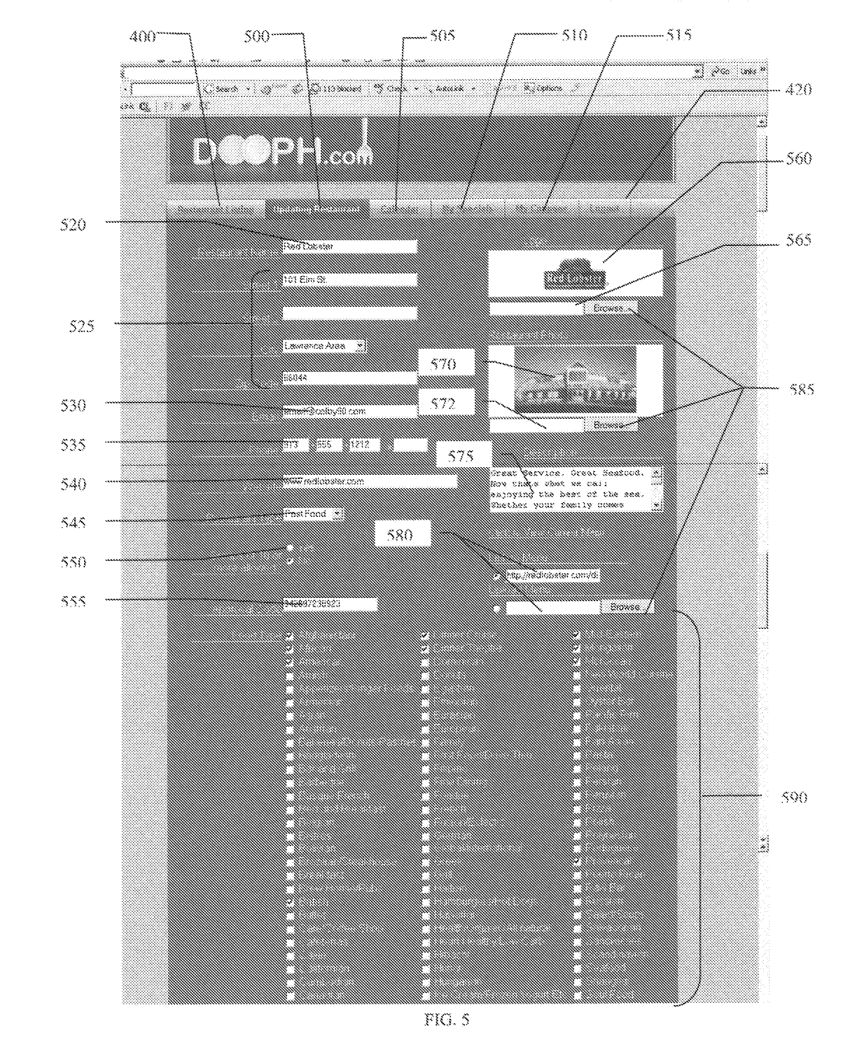

If the manager inputs correct login information, the manager is taken to a display of the restaurant-listing tab 400 as shown in FIG. 4. The manager then chooses what to do next: add or edit a listing, or delete a listing. If the manager chooses the logout tab 420, the session is ended. At any time during these selections, the manager may have the opportunity to logout and end the session. If the manager chooses the delete function 440, the manager will be asked to verify this action. If the manager does not verify, the manager is taken back to the original unchanged restaurant listing. If the manager confirms the deletion, the restaurant listing is updated. The manager is then taken to the restaurant-listing tab 400 and may select another task. If the manager chooses the add restaurant tab 410 or the edit function 430, the manager may be taken to an appropriate page for either adding or editing a restaurant.

The manager may then choose whether or not to display a calendar, which presents an overview of scheduled promotions. If the manager chooses the calendar tab 505, the calendar is displayed. The manager may then choose whether or not to add a coupon or add a special. If the manager decides to engage the add coupon function 770, the manager is taken to the adding coupon 910 tab, where the manager may enter the coupon information. The manager then decides whether or not to save the coupon. If the manager chooses to save it, the listing is updated.

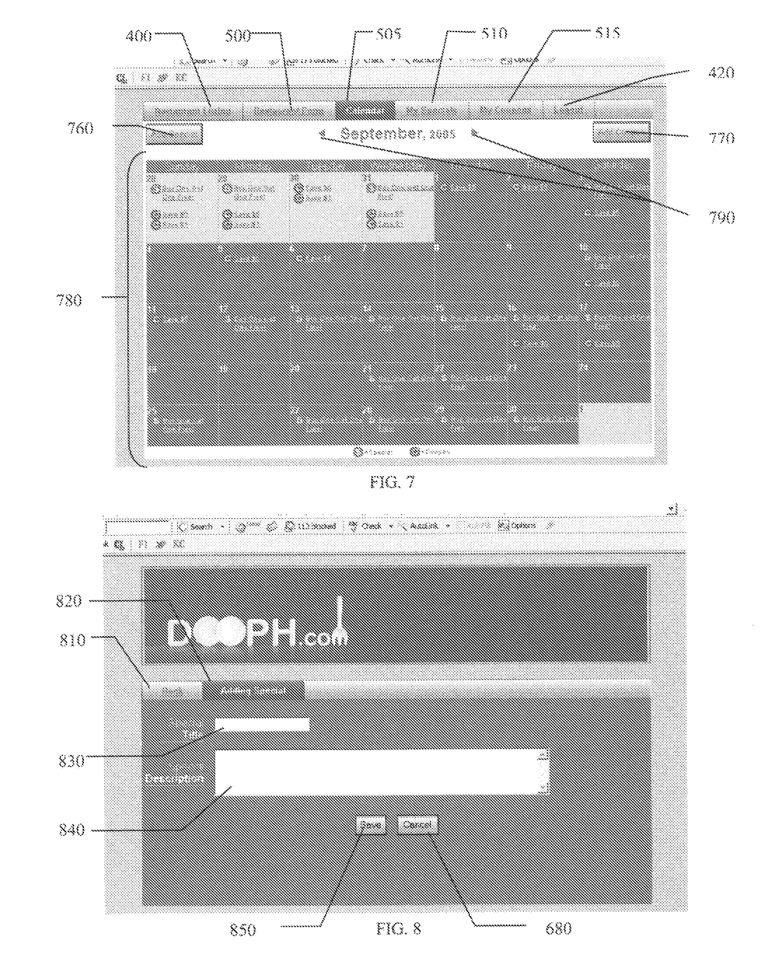

If the manager chooses not to add a coupon or not to save the coupon, the manager may then choose whether or not to add a special. If the manager decides to engage the add special function 760, the manager is taken to the adding special tab 820 as shown in FIG. 8, where the manager may enter the special information. The manager then decides whether or not to save the special. If the manager chooses to save it, the listing is updated. If the manager chooses not to save it, the listing remains unchanged.

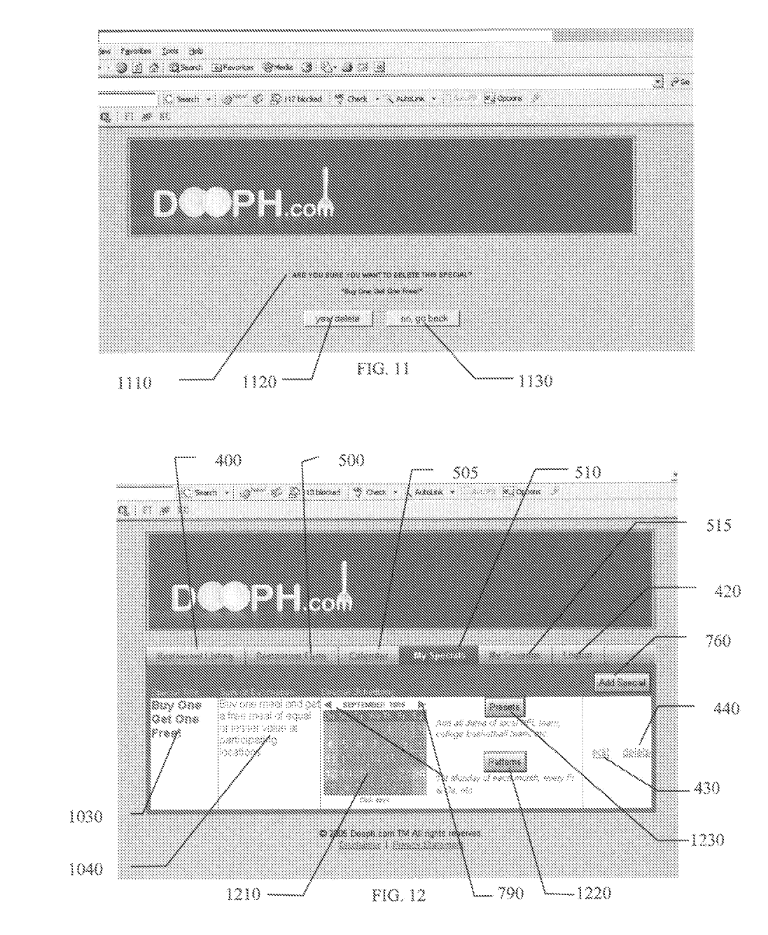

The manager may then choose whether or not to display a specials page, as seen in FIG. 10, which displays an overview of existing specials. If the manager clicks on the specials tab 510, a specials list will be displayed. The manager will then have the opportunity to edit, delete, and/or add specials. The manager will also be able to view special calendars, add presets, and add patterns.

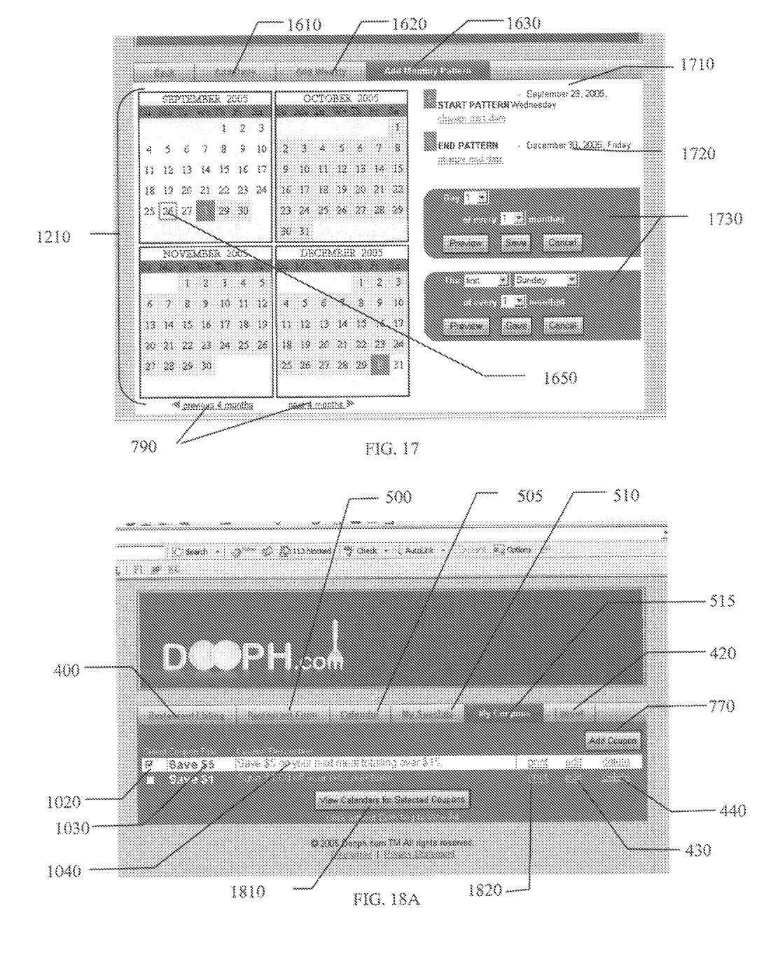

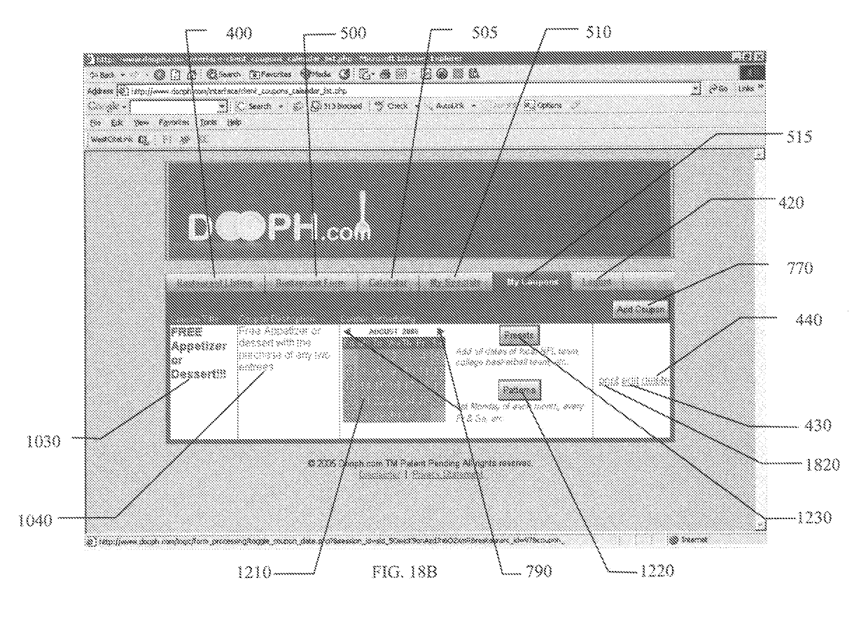

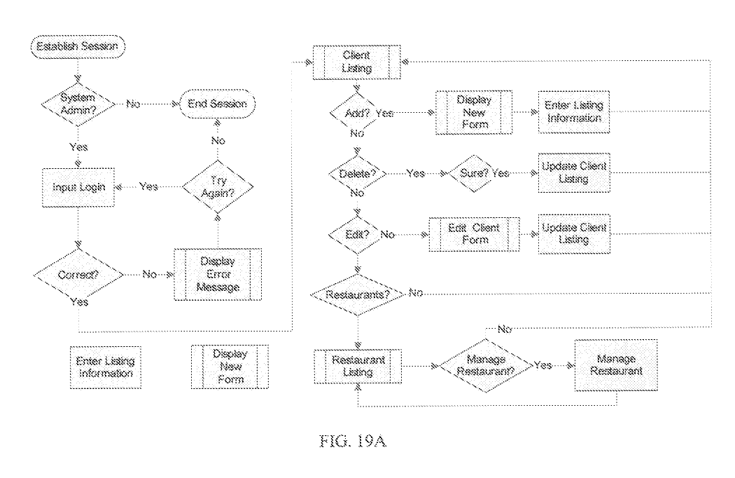

The manager then chooses whether or not to display coupons. If the manager clicks on the my coupons tab 515, a coupons overview listing will be displayed as seen in FIG. 18. The manager will then have the opportunity to edit, delete, and/or add coupons. The manager will also be able to view coupon calendars, add presets, and add patterns.

As previously mentioned, FIGS. 1B-18 illustrate embodiments of the manager interface. In this embodiment, as seen in FIG. 2, the manager must enter a username 210 and password 220, and then engages the submit function 230 to log into the interface. If the manager types in the wrong password or usemame, a login error message 310 will notify him or her, as illustrated in FIG. 3. Once the manager types in a correct password 220 and username 210, the manager is directed to the restaurant listing tab 400, which is a listing of all of that manager's restaurants, as seen in FIG. 4. The listing has a logo display 450, a name display 460, and a description display 470. There are several options that the manager has to choose from: the add restaurant tab 410, the logout tab 420, the edit function 430 and the delete function 440.

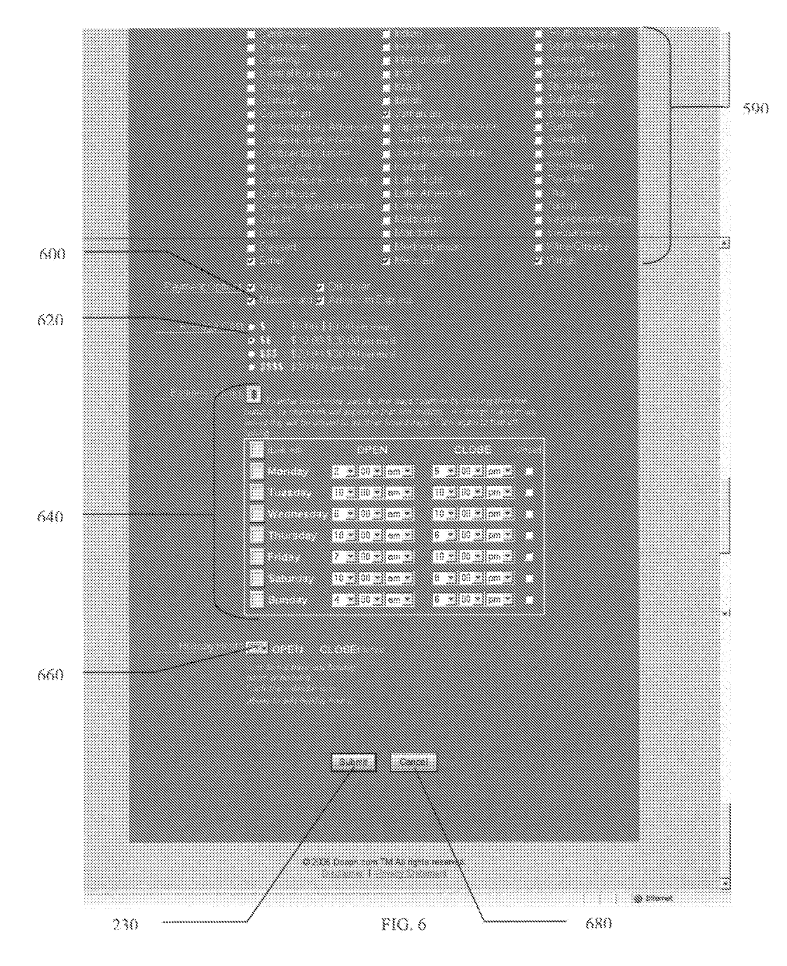

Continuing with FIG. 4, the logout tab 420 ends the manager's session, and takes the manager back to the default search screen. The delete function 440 permanently removes one of the listings from the database 2820 (FIG. 28) after confirming the deletion with the manager. The add restaurant tab 410 takes the manager to an empty form displayed in FIG. 5. The manager then fills in all of the information in each field, such as: the restaurant name field 520; the address fields 525; the e-mail field 530; the phone field 535; and, the website field 540. As illustrated in FIG. 5, the manager may also choose the restaurant type 545, answer the big group question 550, and populate the approval code field 555. The manager may also enter the logo file location 565, the photo file location 572, the written description 575 and the menu file location 580. The manager may fill in the food type 590, the payment options 600, the average cost 620, the business hours 640, and the holiday hours field 660.

A further embodiment of the surplus management disclosed herein may include the ability to upload a map with directions to the restaurant or provide a link to such information. In yet another embodiment, the interface may include the ability to upload menu item nutritional information or provide a link to such information.

As further seen in FIG. 5, when inputting the logo file location 565, the photo file location 572 and the menu file location 580, the manager may optionally engage the browse function 585 to locate the file to be uploaded, instead of typing it. The manager may thereafter engage the cancel function 680 (FIG. 6), thereby not saving any of the information, or the manager may engage the submit function 230 (FIG. 6), thereby saving what has been entered.

As seen in FIG. 5, the manager may update a restaurant after engaging the updating restaurant tab 500. The major difference is that the manager is editing information that has already been entered. If a logo and a photo have already been entered, they will be displayed in the logo display 560 and the photo display 570, respectively. Also, there are three additional tabs on the updating page: the calendar tab 505, the my specials tab 510 and the my coupons tab 515.

As seen in FIG. 7, the calendar tab 505 takes the manager to a calendar display 780, which displays the specials and coupons available for each day of that month. The calendar may cycle through various time frames by engaging either of the navigation arrows 790. There is also an add special function 760 and an add coupon function 770 on that page.

The add special 760 function takes the manager to the adding special tab 820 illustrated in FIG. 8. The manager enters a title in the special title field 830 and a description in the special description field 840. The manager may then engage the save function 850 to save the changes, or engage the cancel 680 function or the back tab 810 to return to leave the list of specials unchanged. The manager may also archive, organize, activate, deactivate, schedule, edit, and delete coupon offerings to users. Managers may enter a description of monetary savings, a date of the promotion's expiration and any other similar promotional restrictions.

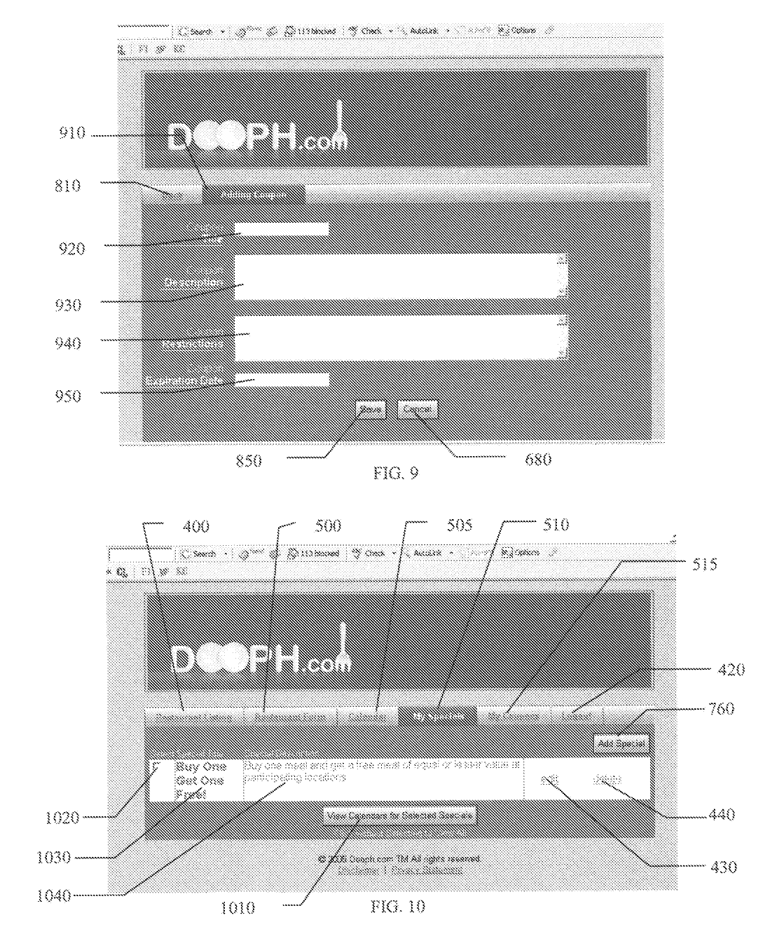

As seen in FIG. 7, the add coupon function 770 takes the manager to the adding coupon tab 910 seen in FIG. 9. The manager then puts the information desired into the coupon title field 920, the coupon description field 930, the coupon restriction field 940, and the coupon expiration date field 950. Optionally, the manager may also press the back 810 function to return to the add special 760 to leave the special unchanged.

Engaging the specials tab 510 takes the subscriber to a list of the manager's specials as seen in FIG. 10. Managers may then organize, activate, deactivate, schedule, edit, and delete specials. The list displays information about each special, such as the title 830 and the description 840. The edit function 430 and the delete function 440 allow the manager to edit or delete each of the specials in the list. As seen in FIG. 11, a warning 1110 is displayed before the deletion is completed. The manager may engage either the yes, delete function 1120 to confirm or cancel the deletion by engaging the no, go-back function 1130.

As seen in FIGS. 10 and 12, the view calendars 1010 function displays calendars for each individual special that has the select field 1020 selected. The view calendars for selected specials function 1010 allows the manager to view the schedule for each special in its own individual miniature event calendar display 1210 showing the days that the one or more specials occur. Each event calendar display 1210 may be cycled through using navigation arrows 790. The title 830 and the description 840 are displayed for each special. Again, the edit function 430 and the delete function 440 allow the manager to edit or delete each of the specials in the list. There is a presets function 1230 and a patterns function 1220 that may be clicked.

The my coupons tab 515 is nearly identically laid out. As seen in FIG. 18, the only difference is the addition of a print function 1820 that allows the coupons to be printed. As seen in FIG. 26, when the print function 1820 is engaged, the coupon information 2610 is displayed, in addition to a print coupon for selected coupons function 2620 that sends the coupon to the printer.

As seen in FIG. 18, the view calendars function 1810 displays calendars for each individual coupon that has the select field 1020 selected (as shown in FIG. 18A). The view calendars for selected coupon function 1810 (FIG. 18A) allows the manager to view the schedule for each coupon in its own individual miniature event calendar display 1210 (FIG. 17) showing the days that the one or more coupons occur. Referring to FIG. 17, each event calendar display 1210 may be cycled through using navigation arrows 790. The title 830 and the description 840 are displayed for each coupon. Again, the edit function 430 and the delete function 440 allow the subscriber to edit or delete each of the coupons in the list. There is a presets function 1230 and a patterns function 1220 that may be clicked.

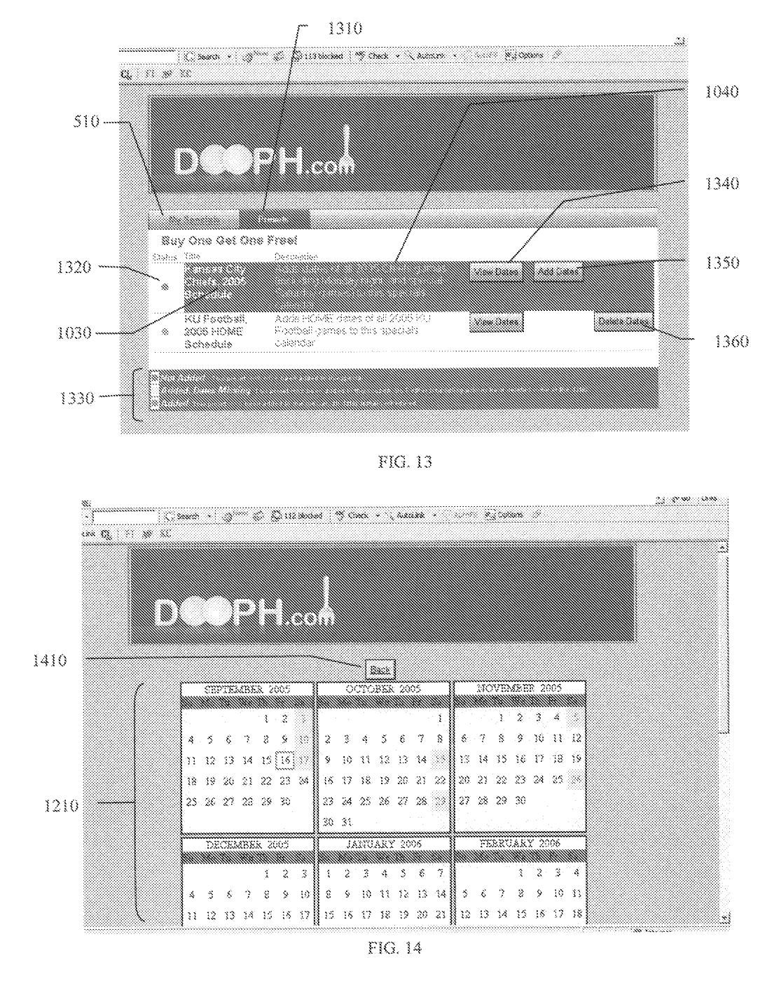

As seen in FIG. 13, the managers may also create their own preset listing. Preset functions or tabs will be in place to schedule according to local sporting teams and other events. To add a new special, a separate box will appear in which restaurant operators enter text describing the special, the price range, etc. The presets function 1230 takes the manager to the presets tab 1310, as seen in FIG. 13. Viewing the presets tab 1310, there is a list of all the presets, their status 1320, title 830, and their description 840. There are three possible statuses: (1) not added, (2) added, dates missing, and (3) added. The status legend 1330 gives the color-coding of the status and explains what each means. There are also three different functions that may be engaged: view dates 1340, the add dates 1350, and the delete dates 1360. Engaging add dates 1350 automatically adds every date in the preset, while delete dates 1360 automatically removes them all. The view dates 1340 function takes the manager to the event calendar display 1210 depicted in FIG. 14. Once there, the manager may navigate to the previous page by engaging the back function 1410.

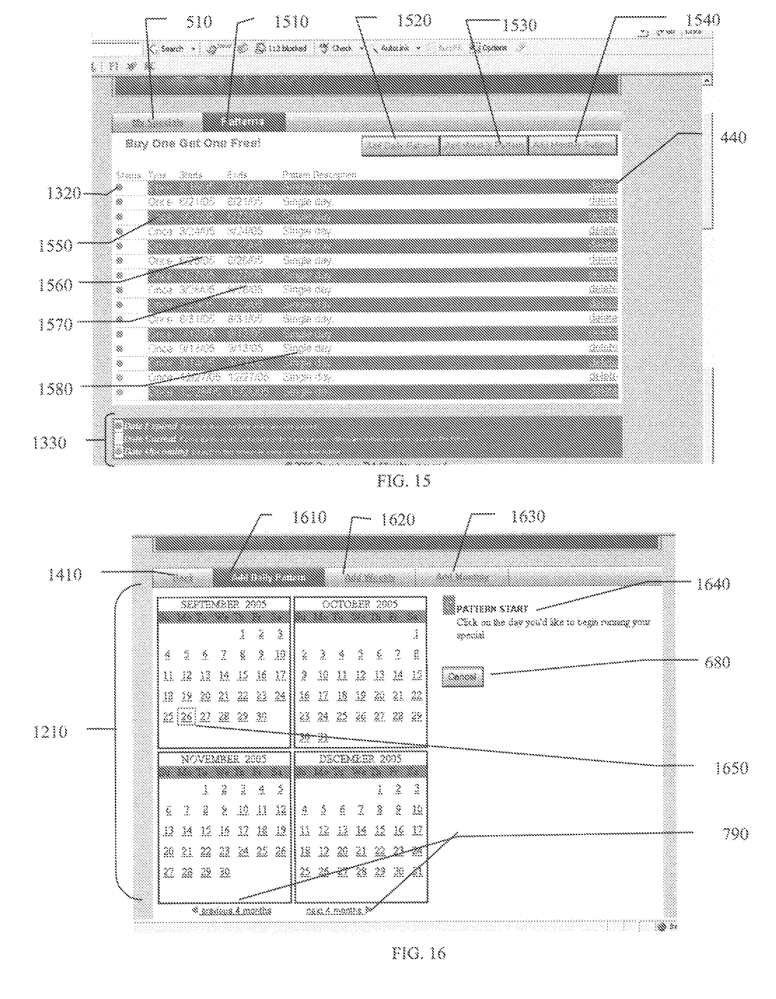

As seen in FIG. 15, the managers may also use patterns to schedule individual specials/offerings by any possible combination of days, weeks, or months for several years in advance. The patterns function 1220 (See FIG. 12) takes the manager to the patterns screen1510, as best seen in FIG. 15. There is a list of all the presets, their status 1320, type 1550, pattern start date 1560, pattern end date 1570, and pattern description 1580. There are three possible statuses: (1) date expired, (2) date current, and (3) date upcoming. The status legend 1330 gives the color-coding and explains what each means. Any of the patterns may be deleted by engaging the delete 440 function. Patterns are created by engaging the desired function: add daily pattern function 1520 (takes to add daily pattern 1610 tab), add weekly pattern function 1530 (takes to add weekly pattern tab 1620), and the add monthly pattern function 1540 (takes to add monthly pattern tab 1630).

The add daily pattern tab 1610 is depicted in FIG. 16. The pattern is selected in the calendar display 1210, which has the current date 1650 in a box. Pattern start instructions 1640 tell the manager how to begin creating their pattern, which may be cancelled anytime by hitting the Cancel function 680. The add monthly pattern screen 1630 is displayed in FIG. 17. The manager selects the adjustable pattern start 1710 and adjustable pattern end dates 1720. The manager may then specify the exact desired pattern in pattern selection 1730.

FIG. 19A represents an embodiment of a system administrator's logical progression through the system administrator interface as displayed on an Internet browser. As seen in FIG. 19A, the system administrator interface allows the system administrator to manage the managers. The flowchart depicted in FIG. 19A begins by determining whether the person or entity is utilizing the embodiment as a system administrator. If utilizing the embodiment as a system administrator, the person or entity will login with an administrative username 210 and password 220 (See FIG. 2). If the person or entity is not utilizing the system as a system administrator, then the session ends. If the information is incorrect, the system administrator is shown a login error message 310 (See FIG. 3) and the system administrator may try logging in again by re-entering the login information.

The surplus management disclosed herein also allows the system administrator to manage the managers. FIG. 19A represents an embodiment of the system administrator's logical progression through the system administrator interface as displayed on an Internet browser. The flowchart begins by determining whether the person or entity is utilizing the embodiment as a system administrator. If the person is not utilizing the system as a system administrator, then the session ends. If utilizing the embodiment as a system administrator, the person or entity will login with an administrative username 210 and password 220. If the information is incorrect, the system administrator is shown a login error message 310 and the system administrator may try logging in again by re-entering the login information.

Once successfully logged in, the system administrator is taken to the global manager-listing tab 1940, which displays a global list of the manager names 1910 and manager descriptions 1920. The system administrator may delete managers by engaging the delete function 440 and edit managers by engaging the edit function 430. The system administrator may also engage the adding manager tab 1950 to add a manager. The system administrator may also edit each manager's presets in the schedule presets tab 1310, as previously described (See FIG. 13), and edit each manager's restaurants by engaging the restaurants function 1930. The restaurants function 1930 directs the system administrator to a manager restaurant listing page 1965, which lists all restaurants owned by a particular manager. As seen in FIG. 19C, this manager restaurant listing 1965 page includes not only access to the edit function 430 and the delete function 440 as previously described (See FIG. 4), but also includes a locations function 1960 which, when engaged, directs the system administrator to a locations list tab 1980, shown in FIG. 19D.

As seen in FIG. 19E, the location-listing tab 1980 allows the system administrator to view all restaurant locations for that particular manager. If the restaurant does not have multiple locations defined in the location-listing tab 1980, a no location error message 1970 is displayed. From the locations list tab 1980, the system administrator may engage the add location function 1975 to display the adding location tab 1985, shown in FIG. 19F. The system administrator may then enter relevant restaurant information pertinent to the new location. Such information may include: the address fields 525, the email field 530, the description field 575, the payment options 600, the average cost 620, the business hours field 640, the holiday hours 660, the groups of 10 or more field 550, the approval code 555, and the restaurant photo upload field 572. The user may optionally engage the browse function 585 to locate a photograph of the restaurant. When complete, the system administrator may engage the submit function 230 to add the location or the cancel function 680 to not add the location. The system administrator is then returned to the locations tab 1980 where he may add, edit, or delete any locations of the restaurant.

The adding manager tab 2050 is depicted in FIG. 20. The system administrator enters the manager name 2010, manager password 2020, manager password verification 2030, and the manager description 2040. The system administrator may also select whether or not to give the manager authority of a system administrator by checking or un-checking the system administrator check box 2060.

If the system administrator chooses the restaurants function 1930 (See FIG. 19C), the system administrator will be presented with the option to add, edit, and delete a manager's restaurants. As seen in FIG. 19C, these functions are identical to the add restaurant 410, edit function 430 and delete function 440 previously described and illustrated in FIG. 4. In addition to the manager's interface, the system administrator may select the manager listing function 1940 (See FIG. 19C) to return to a display of the manager location listing page 1970.

As seen in FIG. 19C, the website also allows the system administrator to manage the managers. The global manager-listing tab 1940 contains a global list of the manager names 1910 and manager descriptions 1920. The system administrator may delete managers by engaging the delete 440 function and edit managers by engaging the edit function 430. The system administrator may also engage the adding manager tab 1950 to add a manager. The system administrator may also edit each manager's presets in the schedule presets tab 1310, as previously described (See FIG. 13), and edit each manager's restaurants by engaging the restaurants function 1930. The restaurants function 1930 directs the system administrator to a manager restaurant listing page 1965, which lists all restaurants owned by a particular manager. As seen in FIG. 19C, this manager restaurant listing page 1965 includes not only access to the edit function 430 and the delete function 440 as previously described (See FIG. 4), but also includes a locations function 1960 which, when engaged, directs the system administrator to a location listing tab 1980, shown in FIG. 19D. As seen in FIG. 19D, the location list page 1970 allows the system administrator to view all restaurant locations for that particular manager. Also seen in FIG. 19D, the add location tab 1975 may be engaged to direct the system administrator to an adding location form tab 1985, shown in FIG. 19E, which allows the system administrator to add new locations to the system. One of skill in the art will appreciate that the functions for adding a location are substantially the same as the functions for updating a restaurant, discussed and shown previously in FIGS. 5 and 6. The substantial difference between the two sets of functions is security access, such that the system administrator has the authority to add locations for any and all manager accounts, whereas a manager may only add or update a restaurant in an account for which a manager has been granted access.

Turning now to FIG. 20, the adding manager tab 2050 is displayed after the system administrator engages the add manager tab 1950. At the adding manager tab 2050, the system administrator enters the manager name 2010, manager password 2020, manager password verification 2030, and the manager description 2040. The system administrator may also select whether or not to give the manager the interface access of a system administrator by checking or un-checking the system administrator check box 2060.

FIG. 21 represents an embodiment of the user's logical progression through the user interface as displayed on an Internet browser. The flowchart depicted in FIG. 21 starts out by determining if the user wishes to conduct a search. If the user does not elect to conduct a search, then the session ends. If the user does elect to conduct a search, the session continues as seen in FIG. 21.

In one embodiment, as seen in FIG. 1B, the website allows users to search for a restaurant or eatery based on food and drink type, geographical location, price range, name, and other factors. FIG. 1B represents a database query page showing a date entry field 110, a zip code entry field 120, a city selection field 130, price range selection 140, type of food selection 150, and establishment type selection 160, according to the embodiment of the surplus management disclosed herein. After entering the data and engaging the go function 170, the website generates a list of all the search results.

The search may be performed by completing the fields depicted in FIG. 1B and by subsequently engaging the go function 170. If there are no results, a no results message 2210 will be displayed, as seen in FIG. 22. The user may then enter new search terms and search again. If the user would like to search more broadly, by restaurant name and date, for example, the searcher may engage the cannot find link 2220. This takes the user to a different search page with a date entry field 110 and restaurant name entry field 2310, as depicted in FIG. 23.

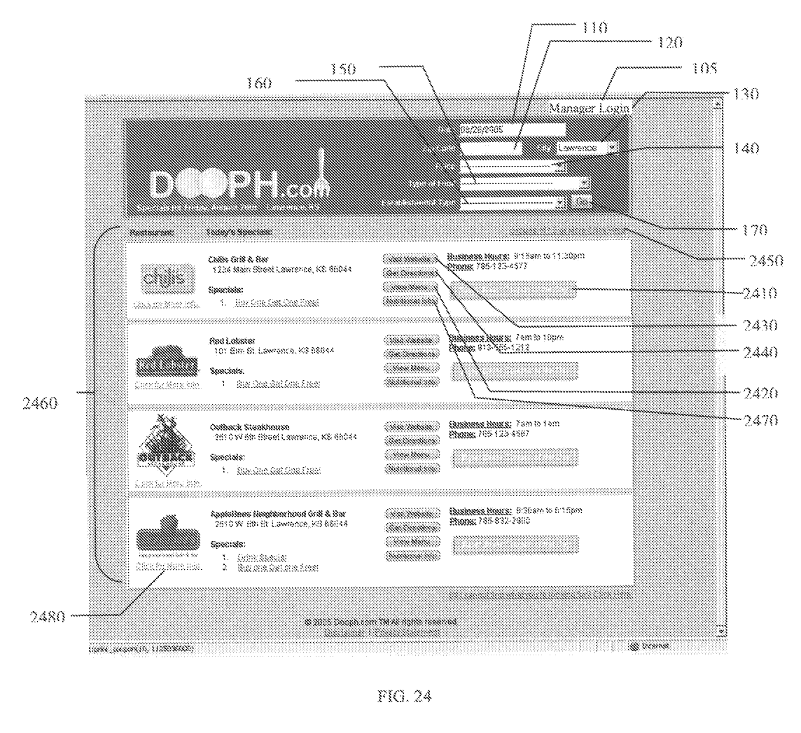

As seen in FIG. 24, the website will display the search results 2460, a list of restaurants and available specials and coupons. When a user clicks on super saver coupon (or like terminology) 2410, the restaurant's profile information, specials, directions, payment options, and the coupon deal will be displayed in a printable pre-determined format or template. The coupon or coupons will be displayed in a separate window, as seen in FIG. 26. The screen with the individual coupon will then have a print coupon function 2620 that sends the image of the coupon to the user's printer.

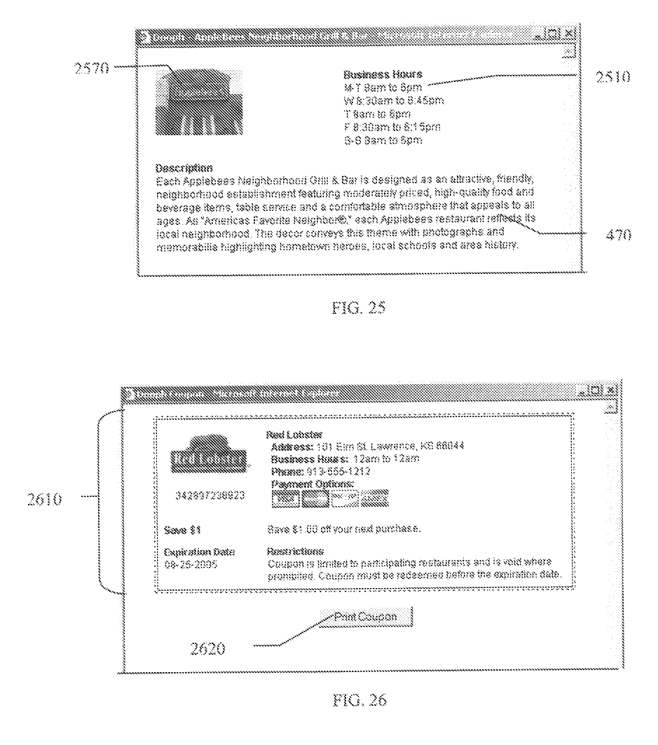

As seen in FIG. 24, the user may also engage the view menu 2420 function to look at the menu, which either displays a file that has been uploaded into database 2820 or links to the menu in a separate browser window. The user may also activate the get directions function 2440 to open a separate browser window to display directions 2440 to the restaurant from popular locations and major highways. The user may also engage the visit website function 2430 to link to the restaurants website or the nutritional information function 2470 to get nutritional information. From the search results, if the “Click for More Info.” function 2480 is clicked, a description appears in a separate window, as depicted in FIG. 25. As entered by the manager, the description 470, the photo 570, and the hours of operation 2510 are displayed accordingly.

As seen in FIG. 24, if the user would like to change the search he or she is able to do so from any page of the site. The display includes, but is not limited to, at least one of the following: date; a clock; logo of each restaurant (which manager may upload); description of the restaurant/eatery (including a picture of the establishment); location; contact information (e.g., phone number); hours of operation website link; directions link; retrieve the super saver coupon of the day coupon function; a listing of all the specials (including links to pictures of the products, etc.); types of food that are listed in the search results; and, the search engine itself to modify the query for additional search results. All restaurants will be listed randomly every time to ensure equal treatment to customers, but may be changed to sort by hours of operation, distance, alphabetical order, etc.

At any time, a user may navigate to the manager login screen (FIG. 2) by engaging the manager login 105, as shown in FIGS. 22, 23 and 24.

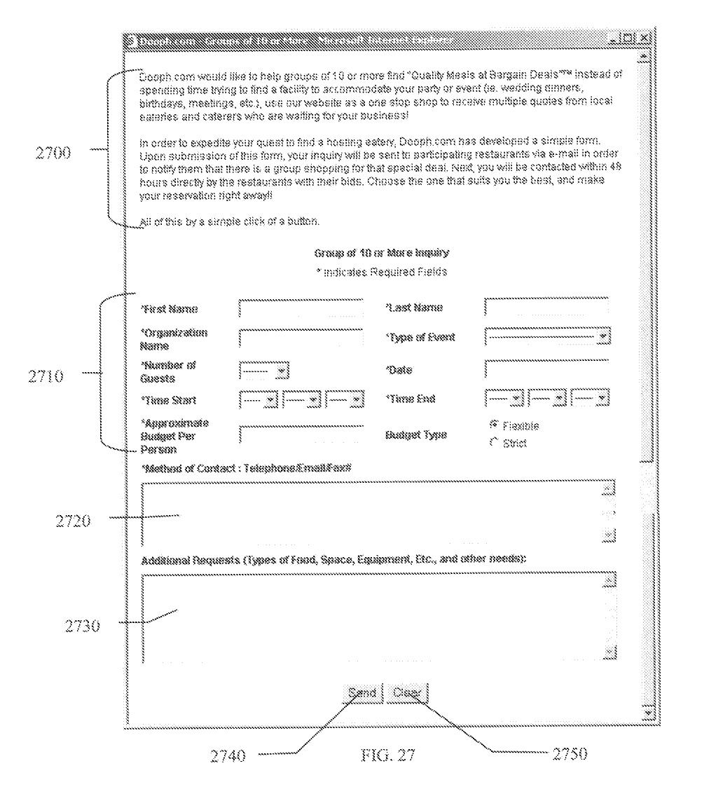

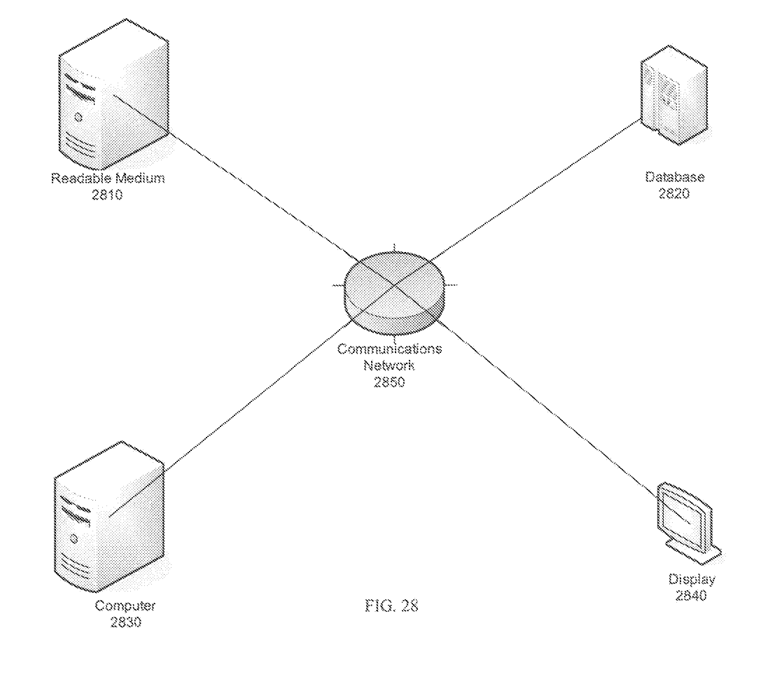

One embodiment provides a group of 10 or more links 2450 for groups or parties of 10 or more. Another embodiment further allows users looking for a reservation to receive multiple quotes from local eateries and caterers. The user fills out the form depicted in FIG. 27. The form description 2700 describes the function of the form that is sent to participating restaurants via e-mail in order to notify them that there is a group searching for a discount price or group price. The restaurants contact the user within 48 hours with their bids, and the user may then choose among the received bids. The website would then ask for much more detailed information, such as: first and last name; date; name of organization; type of event: (with drop down: kid's event, birthday, wedding, reunion, banquet, graduation, anniversary, party, other); number of guests (with drop down: 10-20, 20-30, 30-40, 40-50, 50-up); time (separate drop down for start and for end times); approximate budget per person (have space for amount and drop down for flexible or strict); additional requests (types of food, space, equipment, etc., and other needs); and method of contact (e.g., telephone, e-mail, fax). The participating restaurants get the opportunity to bid for the user's business. The example in FIG. 27 asks for event information 2710, contact information 2720, and Additional requests 2730. The user may then send out this information by engaging the send function 2740, or clear the form and allow the user to start over by pressing the clear function 2750.

An alternate embodiment of the surplus management system disclosed herein includes a group promotions managing module that allows a single operator or a manager managing a group of restaurants to generate and schedule promotions and coupons for a set of restaurants based on one or more predetermined criteria. Thus, for example, using the group promotions managing module, a user can set divide a set of restaurants into a number of different groups, such as restaurants based in certain geographic locations, or restaurants located in certain business area, etc. Subsequently, the user can assign a promotion, a special, etc., to such individual groups. For example, using the group promotions managing module, the operator can assign a special to all restaurants located in a certain states, to all restaurants located in malls, to all restaurants located in airports, etc.

Moreover, the group promotions managing module also allows the operator to calculate efficacy ratios for each various promotions based on the number of coupons printed for such promotions, the number of coupons redeemed for such promotions, the revenues generated by such promotions, etc. Thus, for example, the group promotions managing module may allow a operator to calculate the ratio of number of coupons printed for a promotion to the number of views of the promotion on the website, etc.

Furthermore, an alternate embodiment of the surplus management system disclosed herein allows a user to attach videos to the listing of restaurants. Thus, for example, using the surplus management system, a manager of a restaurant or a chain of restaurants may be able to post a promotional video or an advertisement related to a restaurant to the listing of such restaurant that may be viewed by consumers by selecting a button to activate such videos.

An alternate embodiment of the surplus management system disclosed herein includes an accounting module that allows managers or operators of restaurants to include accounting related to the various transactions generated by their listings, promotions, coupons, etc. Using the accounting module, an operator may be able to generate reports related to the certificates sold for a particular restaurant, group dinners purchased at the website, credit card settlement reports, etc.

Yet another embodiment of the surplus management system disclosed herein includes a user feedback module that allows consumers to provide feedback to a particular restaurant, a particular promotion, a menu item that was part of a particular promotion, etc. Using the user feedback module, an operator of a restaurant chain may be able to determine how consumers, etc., perceived a particular promotion.

An alternate embodiment of the surplus management system disclosed herein is adapted to publish the website, using a wireless access protocol (WAP) or other applicable protocol, on a wireless device and to allow a consumer to locate a restaurant based on the GPS location of the wireless device. Using such a wireless website, a consumer may be able to search for specials, promotion, and coupons for restaurants located in his or her vicinity.

Yet another embodiment of the surplus management system disclosed herein includes a bar management module that allows a manager of a bar or a restaurant to sell and for patrons of the such a bar or a restaurant to buy cover charges for the bar online at a website or using their wireless devices. Such a bar management module also allows a user to reserve or buy a table at the restaurant or the bar for a particular day, time, event, etc. In an alternate embodiment, the bar management module is adapted to allow bar or restaurant managers to auction particular table for particular events, in which case clients may bid for such tables.

As seen in FIG. 28, in one embodiment of the present surplus management disclosed herein, a scheduling and organization system operates from a web-based computer system that includes a network 2850, which consists of the following components: at least one readable medium 2810, at least one database 2820, at least one computer 2830, and at least one display 2840. The interaction may be through a wireless or wired line connection. The computer 2830 may be of any type, including personal computers, workstations, mini-computers, and mainframe computers.

The readable medium 2810 contains instructions for the computer 2830. Until required, the instructions may be stored in another computer readable memory, for example in a hard disk drive, or in a removable memory such as an optical disk for eventual use in a CD-ROM drive or a floppy disk for eventual use in a floppy disk drive. Further, the set of instructions may be stored in the memory of another computer and transmitted over a local area network or a wide area network, such as the Internet, when desired by the user. One skilled in the art will appreciate that the physical storage of the sets of instructions physically changes the medium upon which it is stored electrically, magnetically, or chemically so that the medium carries computer readable information.

The database 2820 contains records of the system administrators, managers, and scheduled activities. The information is accessible from any Web browser connected to the Internet. Examples of such common Web browsers are Microsoft Internet Explorer®, Mozilla Firefox®, Apple Safari® and Netscape Navigator®. In an alternate embodiment, the system may be installed behind a conventional network “firewall” security device, making the system accessible only to browsers connected to and authorized to use intranet.

While the description above refers to particular embodiments of the surplus management disclosed herein, it should be understood that many modifications might be made without departing from the spirit thereof. The accompanying claims are intended to cover such modifications as would fall within the true scope and spirit of the surplus management disclosed herein. The presently disclosed embodiments are therefore to be considered in all respects illustrative and not restrictive, the scope of the surplus management disclosed herein being indicated by the appended claims, rather than the foregoing description, and all changes that come within the meaning and range of equivalency of the claims are therefore, intended to be embraced therein.

What is claimed is:

1. A system for managing surplus, the system comprising:
a promotion module adapted to generate promotions based on the surplus;
a scheduler module adapted to schedule the promotions over a period;
a coupon generation module adapted to generate coupons for the promotion;
a database adapted to store the promotion, the schedule and the coupons; and
a website for publishing the promotion, the schedule and the coupons.

2. The system of claim 1, wherein the promotion module is further adapted to generate promotions based on surplus in a restaurant.

3. The system of claim 1, wherein the scheduler is further adapted to schedule the promotions based on at least one of: (1) a specific day; (2) a regularly scheduled pattern of days; (3) a sports event; and (4) a holiday.

4. The system of claim 2, wherein the website is further adapted to receive data from a user for generating gift certificate for a restaurant, to generate the gift certificate, and to communicate the gift certificate to the user.

5. The system of claim 1, wherein the website is further adapted to at least one of: (1) tally the hits to the website; (2) track hits on a particular restaurant's listing on the website; and (3) track hits on a particular promotion listed on the website.

6. The system of claim 1, further comprising an analysis module communicatively connected to the website to review, manage and statistically analyze data collected on the website.

7. The system of claim 1, wherein the scheduler module is further adapted to schedule a promotion based on a pattern, the pattern being selected from at least one of: hourly; daily, weekly; and monthly.

8. The system if claim 1, further comprising a manager managing module adapted to at least one of: (1) manage a listing of a restaurant; (2) add a manger for the restaurant; and (3) mange the manager of the restaurant.

9. The system of claim 8, wherein
the database is further adapted to store a plurality of attributes of the restaurant, the attribute selected fro the list of: (1) a photograph of the restaurant, (2) a menu of the restaurant, (3) an address of the restaurant, (4) average cost of meal at the restaurant, (5) business hours of the restaurant, (6) payment options for the restaurant, (7) a universal resource locator (URL) of the restaurant, (8) type of food, and (9) a video promotion of the restaurant; and
the website is further adapted to allow the manager to change at least one of the attributes of the restaurant.

10. The system of claim 9, wherein the website is further adapted to allow a user to search a restaurant based on a criteria based on one or more of the attributes.

11. The system of claim 9, wherein the website is further adapted to allow a user to change value of at least one of the attributes.

12. The system of claim 9, wherein the website is further adapted to allow a user to search for a coupon based on at least one of the attributes.

13. The system of claim 2, further comprising a bargain deal module adapted to:
allow a user to request bids for a bargain deal;
receive information from the user about the bargain deal;
communicate the bargain deal information to a plurality of restaurants;
receive bid offers from the plurality of restaurants; and
communicate the bid offers to the user.

14. The system of claim 13, further comprising an automated bid generation module adapted to generate a bid in response to the user request the bid being based on the promotions, the schedules and the coupons stored on the database.

15. The system of claim 1, wherein the website is further adapted to allow a user to print at least one of the coupons.

16. The system of claim 6, wherein the analysis module is further adapted to create an index of at least one of the promotions and coupons based on the number of hits to the website.

17. The system of claim 2, further comprising a group promotions management module adapted to determine a plurality of promotions, to allocate the plurality promotions to a plurality of restaurant groups and to monitor performance of at least one of the plurality of promotions at one of the plurality of restaurant groups.

18. The system of claim 2, further comprising an accounting module that is adapted to provide accounting related to the promotions, the schedules, and the coupons.

19. The system of claim 2, further comprising a user feedback module adapted to allow users to provide feedback about at least one of the restaurant, the promotions and the coupons via the website.

20. The system of claim 1, further comprising a wireless publication module adapted to publish the website on a wireless device using a wireless access protocol.

21. The system of claim 2, further comprising an auction module adapted to allow the restaurant to auction a set of tables using the website and to allow clients to bid on such tables.

22. The system of claim 1, wherein the promotion module is further adapted to generate promotions based on surplus in a bar.

23. The system of claim 22, further comprising a bar management module adapted to allow a bar manager to sell cover charge to the bar via the website.

24. The system of claim 23, wherein the bar management module is further adapted to allow the bar manager to sell a set of tables at the bar via the website.

25. A processor readable medium having encoded thereupon a processor-readable program code which when executed causes a processor to implement a method for managing surplus, the method comprising:
generating promotions based on the surplus;
scheduling the promotions over a period;
generating coupons for the promotion;
storing the promotion, the schedule and the coupons in a database communicatively connected to the processor; and
publishing the promotion, the schedule and the coupons on a website.

26. The processor readable medium of claim 25, wherein the program code is further adapted to generate promotions based on the surplus in at least one of a bar and a restaurant.

27. The processor readable medium of claim 25, wherein the method further comprises:
receiving via the website data from a user for a gift certificate for a restaurant;
generating the gift certificate; and
communicating the gift certificate to the user.

28. The processor readable medium of claim 25, wherein the method further comprises at least one of: (1) tallying the hits to the website; (2) tracking hits on a particular restaurant's listing on the website; and (3) tracking hits on a particular promotion listed on the website.

29. The processor readable medium of claim 25, wherein the method further comprises at least one of: (1) managing a listing of a restaurant; (2) adding a manager for the restaurant; and (3) managing the manager of the restaurant.

30. The processor readable medium of claim 25, wherein the method further comprises selecting one of a plurality of attributes of a restaurant and publishing the one of the plurality of attributes of the restaurant on the website, the plurality of attributes comprising at least one of: (1) a photograph of the restaurant, (2) a menu of the restaurant, (3) an address of the restaurant, (4) average cost of meal at the restaurant, (5) business hours of the restaurant, (6) payment options for the restaurant, (7) a universal resource locator (URL) of the restaurant, (8) type of food, and (9) a video promotion of the restaurant.

31. The processor readable medium of claim 26, further having encoded thereupon a processor-readable bargain deal module program code which when executed causes the processor to:
allow a user to request bids for a bargain deal;
receive information from the user about the bargain deal;
communicate the bargain deal information to a plurality of restaurants;
receive bid offers from the plurality of restaurants; and
communicate the bid offers to the user.

32. The processor readable medium of claim 31, further having encoded thereupon a processor-readable automatic bid generation module program code which when executed causes the processor to generate a bid in response to the user request the bid being based on the promotions, the schedules and the coupons stored on the database.

33. The processor readable medium of claim 26, further having encoded thereupon a processor-readable group promotions management module program code which when executed causes the processor to determine a plurality of promotions, to allocate the plurality promotions to a plurality of restaurant groups and to monitor performance of at least one of the plurality of promotions at one of the plurality of restaurant groups.

34. The processor readable medium of claim 26, further having encoded thereupon a processor-readable user feedback management module program code which when executed causes the processor to allow users to provide feedback about at least one of the restaurant, the promotions and the coupons via the website.

35. A method of managing surplus, the method comprising:
generating promotions based on the surplus;
scheduling the promotions over a period;
generating coupons for the promotion;
storing the promotion, the schedule and the coupons in a database communicatively connected to the processor; and
publishing the promotion, the schedule and the coupons on a website.

36. The method of claim 35, wherein generating promotions further comprises generating promotions for at least one of a bar and a restaurant.

37. The method of claim 36, further comprising:
receiving via the website data from a user for a gift certificate for a restaurant;
generating the gift certificate; and
communicating the gift certificate to the user.

38. The method of claim 36, further comprising:
tallying the hits to the website;
tracking hits on a particular restaurant's listing on the website; and
tracking hits on a particular promotion listed on the website.

39. The method of claim 36, further comprising selling cover charges to the bar via the website.

40. The method of claim 36, further comprising selling tables at one of the bar and the restaurant via the website.

41. The method of claim 36, further comprising publishing at least one of the promotions, the schedules and the coupons on a wireless accessible website.

42. The method of claim 41, further comprising
determining geographic location of a user accessing the wireless accessible website;
finding restaurants in geographic vicinity of the user; and
communicating to the user coupons for the restaurants in geographic vicinity of the user.

43. The method of claim 36, further comprising selecting one of a plurality of attributes of a restaurant and publishing the one of the plurality of attributes of the restaurant on the website, the plurality of attributes comprising at least one of: (1) a photograph of the restaurant, (2) a menu of the restaurant, (3) an address of the restaurant, (4) average cost of meal at the restaurant, (5) business hours of the restaurant, (6) payment options for the restaurant, (7) a universal resource locator (URL) of the restaurant, (8) type of food, and (9) a video promotion of the restaurant.

44. The method of claim 36, further comprising:
publishing a search form on the website;
receiving a plurality of search criteria from the user via the search form;
searching for a restaurant based on the plurality of search criteria; and
communicating the search results to the user.

45. The method of claim 36, further comprising:
allowing a user to request bids for a bargain deal;
receiving information from the user about the bargain deal;
communicating the bargain deal information to a plurality of restaurants;
receiving bid offers from the plurality of restaurants; and
communicating the bid offers to the user.

46. The method of claim 45, further comprising generating a bid in response to the user request a bid based on the promotions, the schedules and the coupons.
